(19) United States
(12) Patent Application Publication
(10) Pub. No.: US 2006/0115190 A1
(43) Pub. Date: Jun. 1, 2006

(54) Bearing structure

(75) Inventors: Wen-Cheng Chen, Taoyuan Hsien (TW); Jin-Juh Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/260,148

(22) Filed: Oct. 28, 2005

(30) Foreign Application Priority Data
Nov. 26, 2004 (TW) 93136449

(51) Int. Cl. F16C 32/06

(52) U.S. Cl. 384/100

(57) ABSTRACT

A bearing structure. A bearing is disposed in a bushing and includes a through hole and a slot. The slot receives a lubricant. An inner wall forming the through hole includes at lease one spiral-shaped furrows for guiding the lubricant into the slot. The inner wall of the bearing is divided into a first section and a second section by the slot. The spiral-shaped furrows on the first section and on the second section have different spiral directions for separately guiding the lubricant into the slot. The lubricant received in the slot can be lubricating oil. The bearing structure prevents leakage of the lubricant and effectively retains the lubricant in the bearing.

This Non-provisional application claims priority under U.S.C. § 119(a) on Patent Application No(s). 093136449 filed in Taiwan, Republic of China on Nov. 26, 2004, the entire contents of which are hereby incorporated by reference.

### BACKGROUND

The invention relates to a bearing structure, and in particular to a bearing structure containing a lubricant.

With advantages of low cost, self-lubrication, high precision, high compatibility with high-speed operation, and ease of mass-production, bearings are widely applied in fans, CPU fans, electric devices for vehicles, household telephones, business machines, stereos, display machines, miniature motors, recorders, stepping motors, spindle motors, and so on.

FIG. 1A is a schematic view of a conventional bearing structure 10. The bearing structure 10 includes a bushing 14 and a bearing 16 which is sintered by powders and disposed in the bushing 14. The bearing 16 has a through hole 11 in which a rotating shaft 12 is rotatably disposed. When the bushing 14 and the bearing 16 are assembled, a space exists between the bottom 18 of the bushing 14 and the bearing 16, and a lubricant is filled in the space and filled between the rotating shaft 12 and the bearing 16.

FIG. 1B is a schematic view of a first bearing 16a of FIG. 1A. Referring both to FIG. 1A and FIG. 1B, the lubricant is uniformly filled in a gap between the rotating shaft 12 and the bearing 16 (16a) so as to stabilize rotation of the rotating shaft 12 and to reduce noise and wear for the bearing 16 (16a). Nevertheless, after the bearing 16 (16a) is operated for a long time, a considerable amount of dust adheres thereto and the lubricant vaporizes due to high temperature caused by friction. When the lubricant is reduced, friction and vibration of the bearing 16 (16a) are increasing. Specifically, the lubricant leaks through the gap between the rotating shaft 12 and the bearing 16 (16a) due to centrifugal force caused by high-speed rotation of the rotating shaft 12. The leaking lubricant contacts the dust and combines with the dust so that the leaking lubricant and the dust combined adhere to the outer surface of the bearing 16 (16a). Accordingly, noise and wear of the bearing 16 (16a) increases and the lifetime of the bearing 16 (16a) is thereby reduced.

As shown in FIGS. 1A and 1B, the bearing 16a has a slippery inner wall, such that the lubricant easily leaks through the through hole 11 during rotation of the rotating shaft 12. For avoiding leakage of the lubricant, the bearing 16a is further processed in order to maintain the lubricant on the bottom 18 of the bushing 14 or in the gap between the rotating shaft 12 and the bearing 16a.

FIG. 1C is a schematic view of a second bearing 16b of FIG. 1A. The inner wall of the bearing 16b disposed in the bushing 14 is formed with multiple fishbone grooves so as to maintain the lubricant in the bearing 16b and form an lubricating film made of the lubricant on the inner wall of the bearing 16b. As shown in FIGS. 1A and 1C, when the rotating shaft 12 rotates, the rotating shaft 12 only contacts the lubricating film so as to reduce wear on the bearing 16b. The bearing 16b, however, can only be applied with a low sideward load. Namely, when the sideward load exceeds a predetermined value, the lubricating film is not resistant to the sideward load. The bearing 16b thus contacts rotating shaft 12.

FIG. 1D is a schematic view of a third bearing 16c of FIG. 1A. The inner wall of the bearing 16c disposed in the bushing 14 is formed with multiple oblique grooves so as to collect the lubricant being congregated close to the bottom 18 of the bushing 14, whereby preventing the lubricant from leaking out of the bushing 14 through the through hole 11 during rotation of the rotating shaft 12. Nevertheless, excessive skewed force is generated during formation of the oblique grooves. Also, the carving area of forming the oblique grooves is increased, which causes failure of concentricity of the bearing 16c. Moreover, the strength of the bearing 16c is insufficient, such that the bearing 16c is easily deformed during rotation.

Matching between the rotating shaft and the bearing of a motor plays an important role in performance of the motor. Also, matching between the rotating shaft and the bearing is affected by formation or processing of complex grooves on the inner wall of the bearing. The strength of the bearing may be insufficient or asymmetry may occur in both sides of the wall of the bearing. Accordingly, the rotating shaft of the motor may deflect during rotation.

Hence, there is a need for a better bearing structure properly processed with low costs to effectively retain a lubricant and prolong the lifetime of a bearing thereof.

### SUMMARY

Accordingly, the invention provides a bearing structure capable of avoiding leakage of a lubricant from a bearing thereof and effectively retaining the lubricant so as to prolong the lifetime of the bearing. The bearing structure is manufactured or processed in a simplified manner, whereby reducing manufacturing difficulty and costs.

An embodiment of the bearing structure includes a bushing and a bearing. The bearing is sintered by powders and disposed in the bushing. The bearing includes a through hole and a slot for receiving a lubricant. The inner wall of the bearing defines a through hole therein, and the inner wall includes at lease one spiral-shaped furrow disposed on the inner wall for guiding the lubricant into the slot. The inner wall of the bearing is divided into a first section and a second section by the slot. The spiral-shaped furrows on the first section and on the second section have different spiral directions for separately guiding the lubricant into the slot. Preferably, the rotating direction of the spiral-shaped furrows on the first section is opposite that of the spiral-shaped furrows on the second section. The lubricant received in the slot includes lubricating oil.

Another embodiment of the bearing structure includes a bushing, a first bearing and a second bearing. The first and second bearings are sintered by powders and separately disposed in the bushing. There is a space formed between the first and second bearings for receiving a lubricant. The inner walls of the first and second bearings respectively include at least one spiral-shaped furrow for guiding the lubricant into the space. The spiral-shaped furrows on the first bearing and the second bearing have different spiral directions for separately guiding the lubricant into the space. Alternatively, the first and second bearings are the same and are oppositely disposed in the bushing. The lubricant received in the space is lubricating oil.

Yet another embodiment of the bearing structure includes a bushing, a bearing, and an oil seal. The bearing and oil seal are disposed in the bushing. There is a first space formed between the bearing and the oil seal for receiving a lubricant. The oil seal prevents leakage of the lubricant. The inner wall of the oil seal further includes at least one groove formed thereon for guiding the lubricant into the first space. The groove on the inner wall of the oil seal includes at least one spiral-shaped furrow or oblique groove for guiding the lubricant into the first space.

Moreover, the bearing is sintered by powders and includes a slot for receiving the lubricant. The inner wall of the bearing defines a through hole therein and the inner wall includes at lease one spiral-shaped furrow for guiding the lubricant into the slot. The inner wall of the bearing is divided into a first section and a second section by the slot. The spiral-shaped furrows on the first section and on the second section have different spiral directions for separately guiding the lubricant into the slot.

Alternatively, the bearing further includes a first bearing, a second bearing. The first and second bearings are sintered by powders and disposed in the bushing. There is a second space formed between the first and second bearings for receiving the lubricant. The inner walls of the first and second bearings respectively include at least one spiral-shaped furrow formed thereon for guiding the lubricant into the second space. The spiral-shaped furrows on the first bearing and the second bearing have different spiral directions for separately guiding the lubricant into the second space. Alternatively, the first and second bearings can be the same, and oppositely disposed in the bushing. The lubricant received in the first and second spaces include lubricating oil.

### DESCRIPTION OF THE DRAWINGS

The invention can be more fully understood by reading the subsequent detailed description and examples with references made to the accompanying drawings, wherein:

FIG. 1A is a schematic view of a conventional bearing structure;

FIG. 1B is a schematic view of a first bearing of FIG. 1A;

FIG. 1C is a schematic view of a second bearing of FIG. 1A;

FIG. 1D is a schematic view of a third bearing of FIG. 1A;

FIG. 2A is a schematic view of the bearing structure of a first embodiment of the invention;

FIG. 2B is a schematic view of the bearing of FIG. 2A;

FIG. 3A is a schematic view of the bearing structure of a second embodiment of the invention;

FIG. 3B is a schematic view of the bearing of FIG. 3A;

FIG. 4A is a schematic view of the bearing structure of a third embodiment of the invention;

FIG. 4B is a schematic view of the first oil seal of FIG. 4A;

FIG. 4C is a schematic view of the second oil seal of FIG. 4A; and

FIG. 4D is a schematic view of the third oil seal of FIG. 4A.

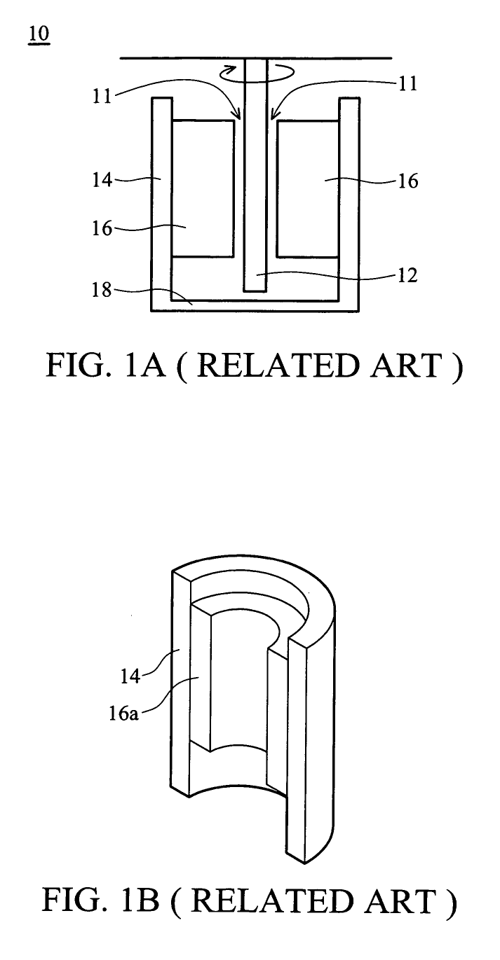

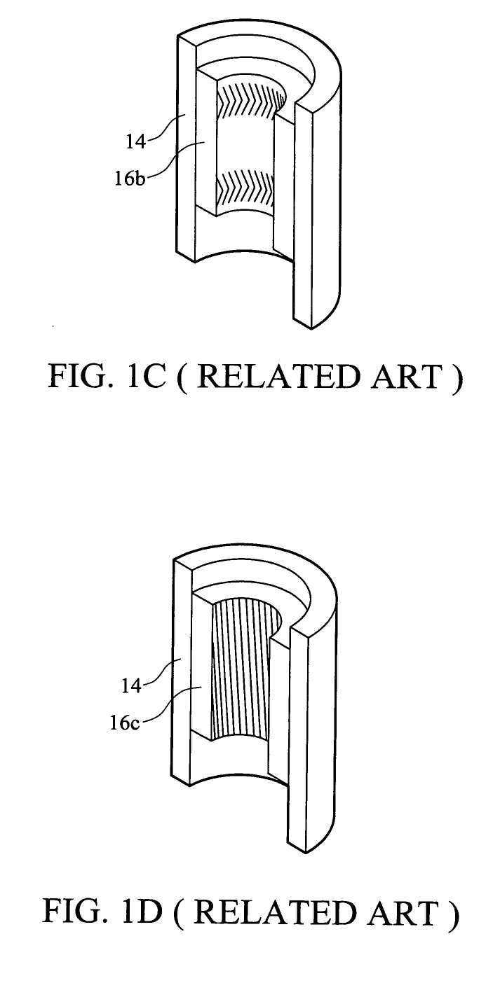

### DETAILED DESCRIPTION

### First Embodiment

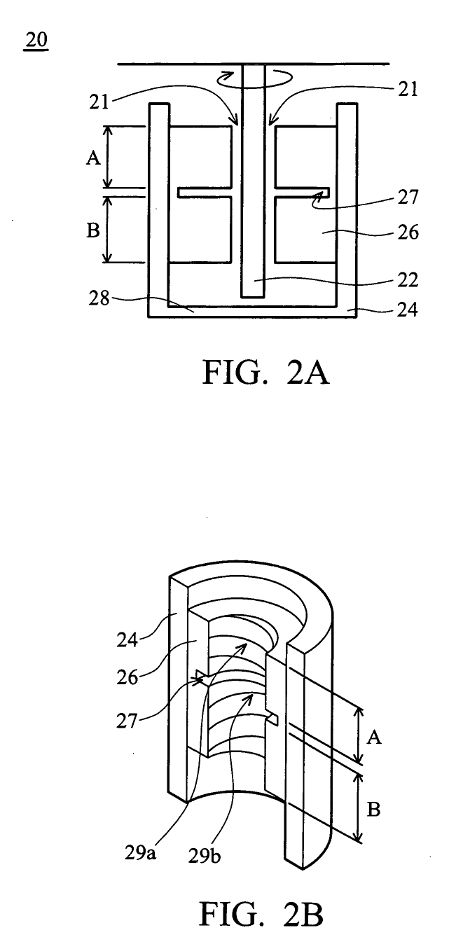

FIG. 2A is a schematic view of the bearing structure 20 of a first embodiment of the invention. The bearing structure 20 includes a bushing 24 and a bearing 26. The bearing 26 is sintered by powders and disposed in the bushing 24. The bearing 26 includes a through hole 21 allowing a rotating shaft 22 to be rotatably disposed therein. When the bushing 24 and the bearing 26 are assembled, a space is formed between the bearing 26 and a bottom 28 of the bushing 24, and a lubricant is filled in the space and filled between the rotating shaft 22 and the bearing 26 so as to reduce friction resulting from high-speed rotation of rotating shaft 22 with respect to the bearing 26, and to reduce vibration of the rotating shaft 22. The bottom 28 of the bushing 24 may be a closed end or an open end. When the bottom 28 of the bushing 24 is an open end, the bottom 28 of the bushing 24 can be closed by an external component. Namely, the bottom 28 can be integrally formed with the bushing 24 or combined with an external component to form a closed end. Accordingly, the lubricant does not leak out of the bushing 24 from the bottom 28. The lubricant can be lubricating oil or other lubricating substances for reducing friction between the rotating shaft 22 and the bearing 26.

FIG. 2B is a schematic view of the bearing 26 of FIG. 2A. As shown in FIG. 2A and FIG. 2B, the bearing 26 includes a slot 27 for receiving the lubricant. Accordingly, the lubricant can be received on the bottom 28 of the bushing 24 and the slot 27. Namely, the lubricant does not completely remain on the bottom 28 of the bushing 24.

Moreover, an inner wall of the bearing 26, defining the through hole 21, includes at lease one spiral-shaped furrow 29a and at least one spiral-shaped furrow 29b for separately guiding the lubricant into the slot 27. The inner wall of the bearing 26 is divided into a first section A and a second section B by the slot 27. The spiral-shaped furrows 29a on the first section A and the spiral-shaped furrows 29b on the second section B have same or different spiral directions. That is, the rotating direction of the spiral-shaped furrow 29a on the first section A can be the same as or opposite to that of the spiral-shaped furrow 29b on the second section B. Preferably, the rotating direction of the spiral-shaped furrow 29b on the second section B is the same as that of the rotating shaft 22, but the rotating direction of the spiral-shaped furrow 29a on the first section A is opposite that of the rotating shaft 22, as shown in FIG. 2B. When the rotating shaft 22 rotates, the lubricant is downwardly guided into the slot 27 along the spiral-shaped furrow 29a and upwardly guided into the slot 27 along the spiral-shaped furrow 29b. Thus, a fine lubricating film is formed on the inner wall of the bearing 26 and the lubricant is filled between the bearing 26 and the rotating shaft 22, whereby reducing wear on the bearing 26 effectively.

### Second Embodiment

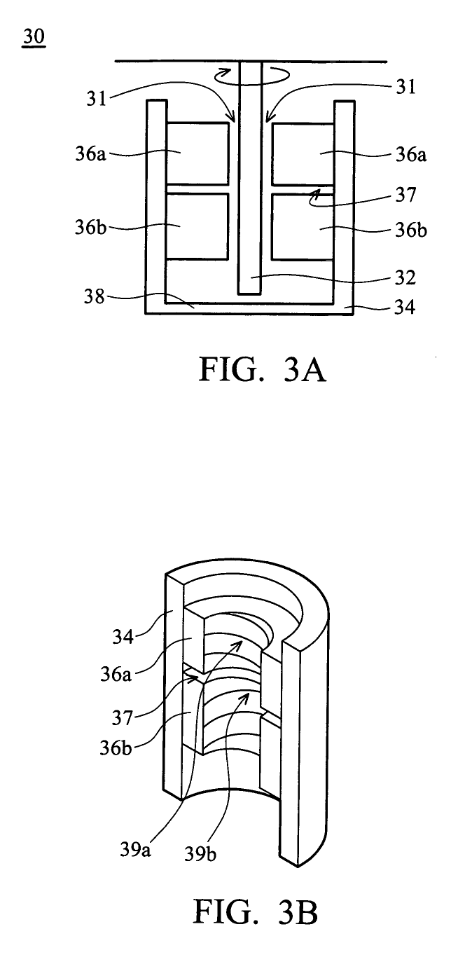

FIG. 3A is a schematic view of the bearing structure 30 of a second embodiment of the invention. The bearing structure 30 includes a bushing 34 and two bearings 36a and 36b. The bearings 36a and 36b are sintered by powders and disposed in the bushing 34. The bearings 36a and 36b include a through hole 31 allowing a rotating shaft 32 to be rotatably disposed therein. When the bushing 34 and the bearings 36a and 36b are assembled, a space 37 is formed between the bearings 36a and 36b and the bushing for receiving a lubricant.

Moreover, a space exists on a bottom 38 of the bushing 34, and a lubricant is filled in the space and filled between the rotating shaft 32 and the bushing 34 so as to reduce friction resulting from high-speed rotation of the rotating shaft 32 with respect to the bearings 36a and 36b, and to reduce vibration of the rotating shaft 32. The bottom 38 of the bushing 34 may be a closed end or an open end. When the bottom 38 of the bushing 34 is an open end, the bottom 38 of the bushing 34 can be closed by an external component. Namely, the bottom 38 can be integrally formed with the bushing 34 or combined with an external component to form a closed end. Accordingly, the lubricant does not leak out of the bushing 34 from the bottom 38. The lubricant can be lubricating oil or other lubricating substances for reducing friction between the rotating shaft 32 and the bearings 36a and 36b.

FIG. 3B is a schematic view of the bearings 36a and 36b of FIG. 3A. As shown in FIG. 3A and FIG. 3B, the space 37 is formed between the bearings 36a and 36b for receiving the lubricant. Accordingly, the lubricant can be received on the bottom 38 of the bushing 34 and the slot 37. Namely, the lubricant does not completely remain on the bottom 38 of the bushing 34.

Moreover, the inner walls of the first and second bearings 36a and 36b, defining the through hole 31, respectively include at least one spiral-shaped furrow 39a and at least one spiral-shaped furrow 39b for separately guiding the lubricant into the space 37. The rotating direction of the spiral-shaped furrow 39a can be the same as or opposite to that of the spiral-shaped furrow 39b. Preferably, the rotating direction of the spiral-shaped furrow 39b on the bearing 36b is the same as that of the rotating shaft 32, but the rotating direction of the spiral-shaped furrow 39a on the bearing 36a is opposite that of the rotating shaft 32, as shown in FIG. 3B. When the rotating shaft 32 rotates, the lubricant is downwardly guided into the space 37 along the spiral-shaped furrow 39a and upwardly guided into the space 37 along the spiral-shaped furrow 39b. Thus, a fine lubricating film is formed on the inner wall of the bearing 36a and 36b, and the lubricant is filled between the bearing 36a and the rotating shaft 32 and between the bearing 36b and the rotating shaft 32, whereby reducing wear on the bearings 36a and 36b effectively.

Generally, a spiral-shaped furrow can be produced using a drill, wherein a bearing is fixed to a working platform and remains concentric to the bit of the drill. The bit penetrates the bearing and is then withdrawn in a direction opposite to the entry direction. Formation of the spiral-shaped furrow is thus complete. Two identical bearings 36a and 36b can be stacked in the same direction and penetrated by the bit to form spiral-shaped furrows with the same rotating direction. Two identical bearings 36a and 36b, however, can be stacked in opposite directions and penetrated by the bit to form spiral-shaped furrows with opposite spiral directions. Accordingly, the spiral-shaped furrows can be formed simultaneously, thereby reducing processing steps and simplifying manufacture thereof.

### Third Embodiment

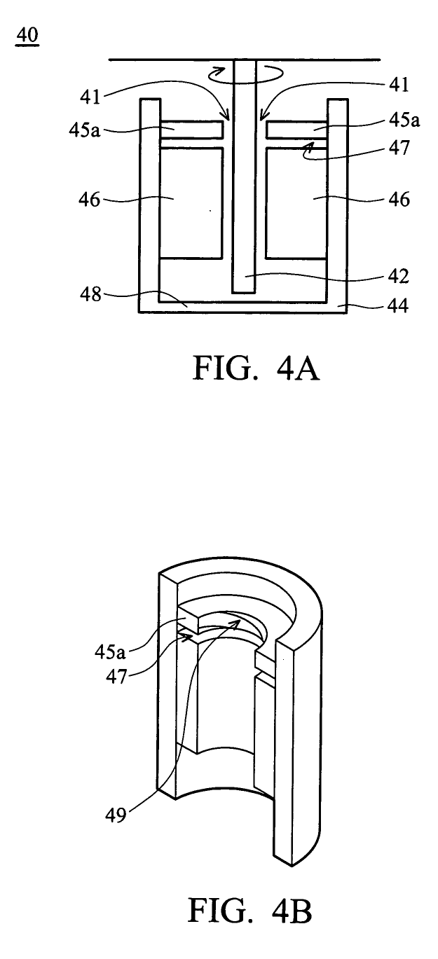

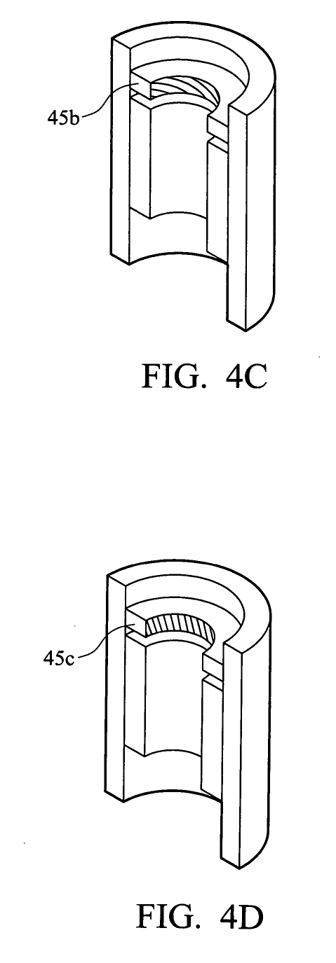

FIG. 4A is a schematic view of the bearing structure 40 of a third embodiment of the invention. The bearing structure 40 includes a bushing 44, a bearing 46, and an oil seal 45a. The bearing 46 and oil seal 45a are disposed in the bushing 44. The bearing 46 includes a through hole 41 allowing a rotating shaft 42 to be rotatably disposed therein.

When the bushing 44 and the bearing 46 are assembled, a space is formed between the bearing 46 and a bottom 48 of the bushing 44, and a lubricant is filled in the space and filled between the rotating shaft 42 and the bushing 44 so as to reduce friction from high-speed rotation of the rotating shaft 42 with respect to the bearing 46, and to reduce vibration of the rotating shaft 42. The bottom 48 of the bushing 44 may be a closed end or an open end. When the bottom 48 of the bushing 44 is an open end, the bottom 48 of the bushing 44 can be closed by an external component. Namely, the bottom 48 can be integrally formed with the bushing 44 or combined with an external component to form a closed end. Accordingly, the lubricant does not leak out of the bushing 44 from the bottom 48. The lubricant can be lubricating oil or other lubricating substances for reducing friction between the rotating shaft 22 and the bearing 46.

FIG. 4B is a schematic view of the first oil seal of FIG. 4A. As shown in FIG. 4A and FIG. 4B, there is further a space 47 formed between the bearing 46 and the oil seal 45a in the bearing structure 40 for receiving a lubricant. The oil seal 45a includes at least one groove 49 formed on the inner wall of the oil seal 45a for guiding the lubricant into the space 47. Additionally, a gap between the oil seal 45a and the rotating shaft 42 is smaller than the diameter of the molecules of the lubricant, so that the lubricant overflowing from the bearing 46 along the through hole 41 is stopped by the oil seal 45a and returns to the bearing 46 along the groove 49 on the oil seal 45a during rotation of the rotating shaft 42. Accordingly, the oil seal 45a can effectively prevent leakage of the lubricant and prevent failure of the gap between the through hole and the bearing, resulting from improper processing of the bearing. Performance of the motor thus does not deteriorate.

Furthermore, referring to FIG. 4C and FIG. 4D, FIG. 4C is a schematic view of the second oil seal 45b of FIG. 4A. FIG. 4D is a schematic view of the third oil seal of FIG. 4A. As shown in FIG. 4C, the inner wall of the oil seal 45b includes at lease one annular spiral-shaped furrows for guiding a lubricant into a lubricant-receiving space (or space). The angle of the annular spiral-shaped furrows is not limited to a specific value. As shown in FIG. 4D, the inner wall of the oil seal 45c includes at lease one oblique grooves for guiding a lubricant into a lubricant-receiving space (or space).

Moreover, the oil seals in this embodiment can be applied with different bearings. For example, the oil seals can be applied to a bearing with a slot as described in the first embodiment, or applied to two bearings with a space disposed therebetween as described in the second embodiment for receiving the lubricant.

In conclusion, the simple processing manner applied to form the grooves on the inner wall of the bearing reduces adverse affects of matching between the bearing and the rotating shaft. The strength of the bearing is not reduced, nor is asymmetry on sides of the wall of the bearing. Moreover, the lubricant-receiving space (slot or space) in the single bearing as described in the first embodiment, between two bearings as described in the second embodiment, or between the bearing and the oil seal as described in the third embodiment, serves as a buffer space for lubricant. The grooves or spiral-shaped furrows on the inner wall of the bearing or oil seal guide the lubricant into the buffer space, whereby preventing leakage of the lubricant during high-speed rotation of the rotating shaft. Accordingly, the bearing structures of the invention can effectively maintain a lubricant therein and prolong the lifetime of the bearings. Additionally, the bearing structures of the invention can be manufactured using a simplified manner, thus reducing manufacturing difficulty and costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bearing structure, comprising:
a bushing;
a bearing disposed in the bushing; and
a slot formed in the bearing for receiving a lubricant.

2. The bearing structure as claimed in claim 1, wherein the bearing comprises an inner wall defining a through hole therein, and the inner wall comprises at lease one spiral-shaped furrow disposed on the inner wall for guiding the lubricant into the slot.

3. The bearing structure as claimed in claim 2, wherein the inner wall of the bearing is divided into a first section and a second section by the slot, and the spiral-shaped furrows on the first section and on the second section have different spiral directions for separately guiding the lubricant into the slot.

4. The bearing structure as claimed in claim 1, wherein a bottom of the bushing is a closed end.

5. The bearing structure as claimed in claim 1, wherein a bottom of the bushing is an open end and the bottom of the bushing is closed by an external component.

6. A bearing structure, comprising:
a bushing;
a first bearing disposed in the bushing; and
a second bearing disposed in the bushing; wherein there is a space formed between the first bearing and the second bearing for receiving a lubricant.

7. The bearing structure as claimed in claim 6, wherein inner walls of the first bearing and the second bearing respectively comprise at least one spiral-shaped furrow for guiding the lubricant into the space.

8. The bearing structure as claimed in claim 7, wherein the spiral-shaped furrows on the first bearing and the second bearing have different spiral directions for separately guiding the lubricant into the space.

9. The bearing structure as claimed in claim 7, wherein the first bearing and the second bearing are the same and are oppositely disposed in the bushing.

10. The bearing structure as claimed in claim 6, wherein a bottom of the bushing is a closed end.

11. The bearing structure as claimed in claim 6, wherein a bottom of the bushing is an open end and the bottom of the bushing is closed by an external component.

12. A bearing structure, comprising:
a bushing;
a bearing disposed in the bushing; and
an oil seal disposed in the bushing for avoiding leakage of a lubricant; wherein there is a first space formed between the bearing and the oil seal for receiving the lubricant.

13. The bearing structure as claimed in claim 12, wherein the oil seal comprises at least one furrow formed on an inner wall of the oil seal for guiding the lubricant into the first space.

14. The bearing structure as claimed in claim 13, wherein the furrow on the inner wall of the oil seal comprises a spiral-shaped furrow or an oblique furrow.

15. The bearing structure as claimed in claim 12, wherein the bearing comprises a slot for receiving the lubricant, and an inner wall of the bearing comprises at lease one spiral-shaped furrows for guiding the lubricant into the slot.

16. The bearing structure as claimed in claim 15, wherein the inner wall of the bearing is divided into a first section and a second section by the slot, and the spiral-shaped furrows on the first section and on the second section have different spiral directions for separately guiding the lubricant into the slot.

17. The bearing structure as claimed in claim 12, wherein the bearing comprises a first bearing and a second bearing, and there is a second space formed between the first bearing and the second bearing for receiving the lubricant.

18. The bearing structure as claimed in claim 17, wherein inner walls of the first bearing and the second bearing respectively comprise at least one spiral-shaped furrow formed thereon for guiding the lubricant into the second space.

19. The bearing structure as claimed in claim 18, wherein the spiral-shaped furrows on the first bearing and the second bearing have different spiral directions for separately guiding the lubricant into the second space.

20. The bearing structure as claimed in claim 18, wherein the first bearing and the second bearing are the same and are oppositely disposed in the bushing.
